(19) United States
(12) Patent Application Publication
(10) Pub. No.: US 2013/0200719 A1
(43) Pub. Date: Aug. 8, 2013

(54) CONTROL DEVICE AND WIRELESS POWER TRANSMITTING APPARATUS

(71) Applicants: Hiroaki ISHIHARA, Kawasaki-Shi (JP); Kohei ONIZUKA, Tokyo (JP); Fumi MORITSUKA, Kawasaki-Shi (JP); Shoji OTAKA, Yokohama-Shi (JP)

(72) Inventors: Hiroaki ISHIHARA, Kawasaki-Shi (JP); Kohei ONIZUKA, Tokyo (JP); Fumi MORITSUKA, Kawasaki-Shi (JP); Shoji OTAKA, Yokohama-Shi (JP)

(73) Assignee: KABUSHIKI KAISHA TOSHIBA, Tokyo (JP)

(21) Appl. No.: 13/719,078

(22) Filed: Dec. 18, 2012

(30) Foreign Application Priority Data
Feb. 8, 2012 (JP) 2012-024904

(51) Int. Cl. H02J 17/00; H02M 5/42

(52) U.S. Cl. CPC H02J 17/00; H02M 5/42
USPC 307/104; 363/15

(57) ABSTRACT

There is provided a control device that estimates power transmission efficiency between a power transmitting unit and a power receiving unit. The power transmitting unit includes a first coil and a first capacitor connected to the first coil in parallel or in series. The power receiving unit includes a second coil and a second capacitor connected to the second coil in parallel or in series and receives electric power from the power transmitting unit through a coupling between the first coil and the second coil. The control device includes an estimator. The estimator compares a detected value of a first voltage or a first current at a first location in the power transmitting unit with a detected value of second voltage or second current at a second location in the power receiving unit and estimates the power transmission efficiency from the power transmitting unit to the power receiving unit.

### CROSS REFERENCE TO RELATED APPLICATIONS

This application is based upon and claims the benefit of priority from the prior Japanese Patent Application No. 2012-024904, filed on Feb. 8, 2012, the entire contents of which are incorporated herein by reference.

### FIELD

Embodiments described herein relate to wireless power transmission.

### BACKGROUND

In wireless power transmission, it is known that a transmission efficiency of electric power is changed depending on a transmission distance and load impedance. Efficiency is defined below as a ratio of electric power supplied from a power source on the power transmission side and received electric power on the reception side. From the point of view of effective utilization of electric power energy, in the wireless power transmission, it is desirable that electric power supplied to the power transmission side is supplied to the power reception side with a loss as small as possible, that is, that the efficiency is improved.

Conventionally, a method has been known in which efficiency is controlled when a transmission condition such as a transmission distance is changed. In this method, certain means that changes the configuration of a power transmitting and receiving element is provided, and efficiency before and after the power transmitting and receiving element is changed is calculated and compared with each other to control the power transmitting and receiving element so that the efficiency is improved.

However, in the above-described related art, efficiency needs to be directly calculated to improve the efficiency. To calculate the efficiency, information on voltage and current of the power transmission side, and voltage and current of the power reception side is needed.

### BRIEF DESCRIPTION OF THE DRAWINGS

FIG. 1 is a diagram illustrating a configuration of a wireless power transmitting apparatus according to a first embodiment, which includes a control device that estimates transmission efficiency;

FIG. 2 is a diagram for explaining an example of estimation of efficiency using voltage applied to a capacitor;

FIG. 3 is a diagram for explaining an example of estimation of efficiency using voltage applied to a coil;

FIG. 4 is a diagram for explaining an example of estimation of the transmission efficiency using current that flows through a capacitor;

FIG. 5 is a diagram illustrating a configuration of the wireless power transmitting apparatus according to the first embodiment, in which the coil and the capacitor are connected to each other in parallel;

FIG. 6 is a diagram illustrating a configuration of the wireless power transmitting apparatus according to the first embodiment, which includes a DC-AC converter and an AC-DC converter;

FIG. 7 is a diagram illustrating a configuration of a wireless power transmitting apparatus according to a second embodiment, which includes a control device that adjusts efficiency by feedback;

FIG. 8 is a diagram illustrating an operation flow in the control device illustrated in FIG. 7;

FIG. 9 is a diagram illustrating a detailed configuration example of the control device illustrated in FIG. 7;

FIG. 10 is a diagram illustrating a configuration of a wireless power transmitting apparatus according to a third embodiment, which performs efficiency control while performing electric power control;

FIG. 11 is a diagram illustrating another configuration of the wireless power transmitting apparatus according to the third embodiment, which performs efficiency control while performing electric power control; and

FIG. 12 is diagrams illustrating a connection configuration of a coil and a capacitor.

### DETAILED DESCRIPTION

According to some embodiments, there is provided a control device that estimates power transmission efficiency between a power transmitting unit that includes a first coil and a first capacitor that is connected to the first coil in parallel or in series, and a power receiving unit that includes a second coil and a second capacitor that is connected to the second coil in parallel or in series and receives electric power from the power transmitting unit through a coupling between the first coil and the second coil.

The control device includes an estimator configured to compare a detected value of a first voltage or a first current at a first location in the power transmitting unit with a detected value of second voltage or second current at a second location in the power receiving unit and estimate the power transmission efficiency from the power transmitting unit to the power receiving unit based on comparative result.

Hereinafter, embodiments will be described in detail with reference to the accompanying drawings.

### First Embodiment

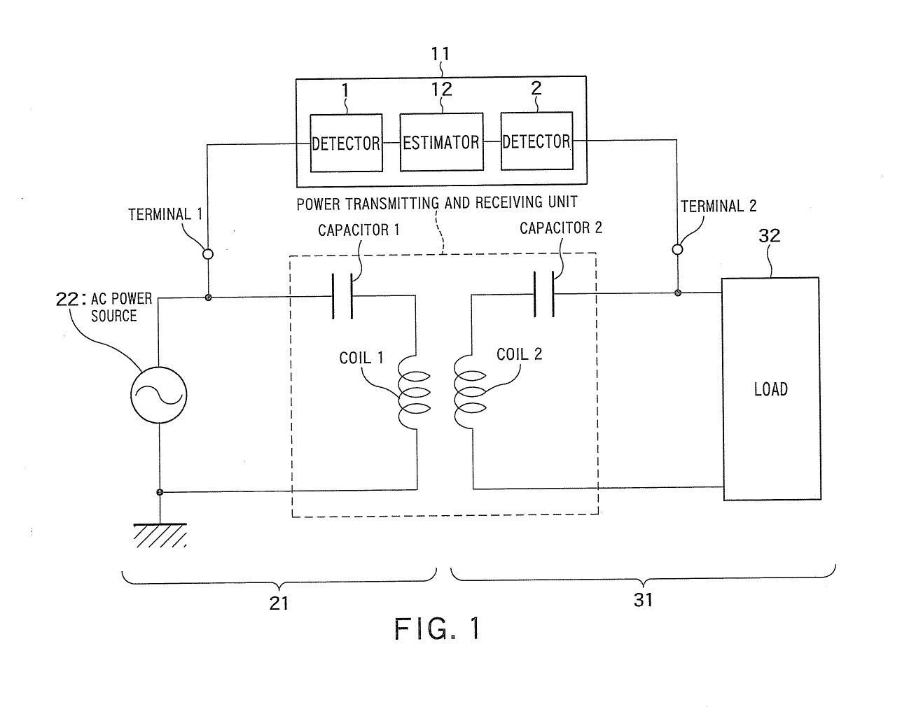

FIG. 1 illustrates a wireless power transmitting apparatus according to a first embodiment, which includes a control device.

The wireless power transmitting apparatus includes a power transmitting unit 21 that transmits electric power, a power receiving unit 31 that receives electric power, and a control device 11. The control device 11 may be built in the power transmitting unit 21 or the power receiving unit 31, or may be provided separately from the power transmitting unit 21 and the power receiving, unit 31.

The power transmitting unit 21 includes an AC power source 22 that generates electric power signals (AC voltage signals) and a coil 1 and a capacitor 1 that are connected to the AC power source 22. The coil 1 and the capacitor 1 are connected to each other in series.

The power receiving unit 31 includes a load 32, and a coil 2 and a capacitor 2 that are connected to the load 32. The coil 2 and the capacitor 2 are connected to each other in series. The load 32 may be a certain device that consumes or stores electric power.

A power transmitting and receiving unit is constituted of the coil 1 and the capacitor 1 on the power transmission side and the coil 2 and the capacitor 2 on the power reception side, and power transmission through magnetic coupling is performed in the power transmitting and receiving unit. In the coil 1, a magnetic field is generated in accordance with the electric power signal from the AC power source 22, and the electric power signal is transmitted to the power reception side by coupling the magnetic field to the coil 2. The transmitted electric power is supplied to the load 32 and is consumed at or stored in the load 32.

In the power transmitting unit 21, a terminal 1 is provided to detect voltage at one end on a side opposite to the coil 1 of both the ends of the capacitor 1, that is, input voltage to the power transmitting and receiving unit. In addition, in the power receiving unit 31, a terminal 2 is provided to detect voltage at one end on a side opposite to the coil 2 of both the ends of the capacitor 2, that is, output voltage of the power transmitting and receiving unit.

The control device 11 includes a detector 1, a detector 2, and an estimator 12. The detector 1 detects voltage at a predetermined location of the power transmitting unit 21, specifically, voltage of the terminal 1. The detector 2 detects voltage at a designated location of the power receiving unit 31, specifically, voltage of the terminal 2. The estimator 12 estimates the transmission efficiency of electric power from the power transmitting unit 21 to the power receiving unit 31 based on the voltage detected by the detector 1 and the voltage detected by the detector 2. It is noted that the detectors 1 and may be provided outside the control device 11 as an independent device, or inside another certain device.

The control device 11 can control the power transmission based on the voltage (or current, which will be described in detail later) detected by the detector 1 and the voltage (or current, which will be described in detail later) detected by the detector 2, without calculating an estimation value of the transmission efficiency of electric power. Such a form in which the power transmission is controlled without calculating an estimation value of the transmission efficiency of electric power is included in a form in which the control device 11 estimates the transmission efficiency of electric power.

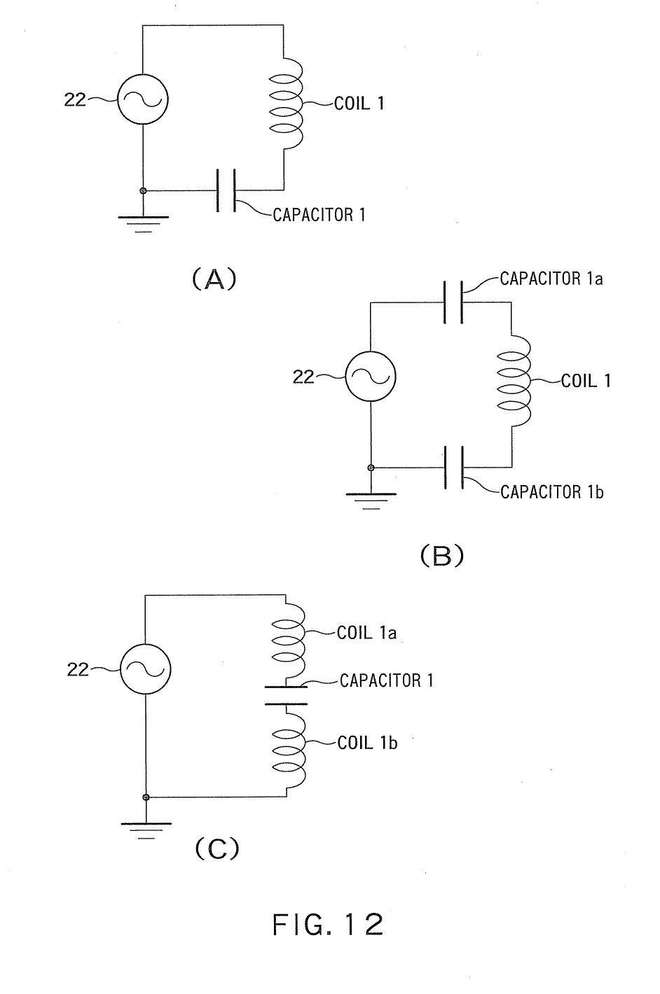

It is noted that, in FIG. 1, the capacitor 1 is connected to an output side of the AC power source 22 and the coil 1 is connected to a ground terminal side; however, as illustrated in FIG. 12(A), a configuration may be provided in which the connection order are interchanged. The same configuration may be provided on the power reception side.

In addition, the connection may be performed by dividing one of the capacitor 1 and the coil 1 or both of the capacitor 1 and the coil 1 into a plurality of parts. For example, when the capacitor 1 is divided into two, capacitors 1a and 1b are connected to both the sides of the coil 1, respectively, as illustrated in FIG. 12(B). Alternatively, when the coil 1 is divided into two, coils 1a and 1b are connected to both the sides of the capacitor 1, respectively, as illustrated in FIG. 12(C). In this case, electric power is transmitted to the power reception side through the two coils 1a and 1b. It is noted that the number of divided parts is not limited to two, and the number of divided parts may be three or more. The same configuration may be provided on the power reception side.

A specific operation of the present device will be described below.

When a resonant frequency of an LC resonant circuit including the capacitor 1 and the coil 1, and a resonant frequency of an LC resonant circuit including the capacitor 2 and the coil 2 are well close to a frequency of electric power that is output from the AC power source 22, the transmission efficiency of electric power that is transmitted between the coils is represented by the following equation.

$$Eff = \frac{{k}^{2} {wL}_{2} {Q}_{1} {Q}_{2}^{2} {R}_{L}}{{Q}_{2}^{2} {R}_{L}^{2} + ( {k}^{2} {wL}_{2} {Q}_{1} {Q}_{2}^{2} + 2 {wL}_{2} {Q}_{2} ) {R}_{L} + {k}^{2} {w}^{2} {L}_{2}^{2} {Q}_{1} {Q}_{2} + {w}^{2} {L}_{2}^{2}} \qquad ( 1 )$$

Here, “L₁.” indicates inductance of the coil 1, “L₂” indicates inductance of the coil 2, “k” indicates a coupling coefficient between the coils, “Q₁” indicates a Q value of the coil 1, “Q₂” indicates a Q value of the coil 2, and “R_{L}” indicates a resistance value (impedance) of the load 32.

The transmission efficiency depends on the resistance value of the load 32, and a maximum value is obtained when the load resistance value satisfies the following equation.

$${R}_{Lopt} = \frac{{wL}_{2} \sqrt{( {k}^{2} {Q}_{1} {Q}_{2} + 1 )}}{{Q}_{2}} \qquad ( 2 )$$

When the load resistance value satisfies the above equation (2) and the efficiency becomes maximum, the voltage of the terminal 1 and the voltage of the terminal 2 satisfy the following equation.

$${V}_{2} = {V}_{1} j \frac{k * \sqrt{{L}_{1} {L}_{2}} {Q}_{1} \sqrt{{k}^{2} * {Q}_{1} * {Q}_{2} + 1}}{{L}_{1} \sqrt{{k}^{2} {Q}_{1} {Q}_{2} + 1} + {k}^{2} {L}_{1} {Q}_{1} {Q}_{2} + {L}_{1}} \qquad ( 3 )$$

Here, “V₁” indicates the voltage of the terminal 1, and “V₂” indicates the voltage of the terminal 2. Any value of voltage may be provided as long as the value is a value, such as a root mean square (rms) value and a peak value, which is determined based on AC voltage amplitude.

When absolute values are obtained in the above equation (3), the following equation is obtained in a case of “k²Q₁Q₂>>1”, and a voltage ratio is substantially equal to “√(L₂/L₁)√(Q₁/Q₂).”

$$\vert {V}_{2} \vert \approx \vert {V}_{1} \vert \sqrt{\frac{{L}_{2}}{{L}_{1}}} \sqrt{\frac{{Q}_{1}}{{Q}_{2}}} \qquad ( 4 )$$

Here, when parasitic resistance values of “L₁” and “L₂” are “R₁.” and “R₂,” respectively, the above equation (4) becomes the following equation.

$${V}_{2} \approx {V}_{1} \sqrt{\frac{{R}_{2}}{{R}_{1}}} \qquad ( 5 )$$

The “√(R₂/R₁)” is a square root of a ratio of the parasitic resistance of the coil 1 and the parasitic resistance of the coil 2. That is, closeness between the resistance of the load 32 currently connected and a load resistance value having optimal efficiency can be determined by comparing the voltage ratio of the terminal 1 and the terminal 2 with a predetermined value (threshold value) that is determined based on a parasitic resistance ratio of the coil 1 and the coil 2. In other words, the power transmission efficiency can be estimated by detecting the voltage of the terminal 1 and the voltage of the terminal 2. Conventionally, it has been necessary to calculate transmitted power and received power for calculation of the transmission efficiency; however, in the present embodiment, there is no need to do so, and it is sufficient to detect only the voltage. Therefore, the transmission efficiency can be simply estimated.

It is noted that, when the parasitic resistance components of the capacitor 1 and the capacitor 2 are too large to be disregarded with respect to the parasitic resistance components of the coil 1 and the coil 2, respectively, the “R₁” may be a value that includes parasitic resistance of the capacitor 1, and the “R₂” may be a value that includes parasitic resistance of the capacitor 2.

As a specific method of transmission efficiency estimation that is performed by the estimator 12 in the control device 11, various forms are conceivable.

For example, a ratio (or difference) of the “V₁” and “V₂” may be calculated, and the calculated voltage ratio (or difference) itself may be regarded as an index that indicates the efficiency.

In addition, the closeness between the voltage ratio and the “√(R₂/R₁)” (that is, the load resistance value having optimal efficiency) is determined by calculating a ratio (or difference) of the calculated voltage ratio and the “√(R₂/R₁)”, and the ratio may be regarded as the efficiency. In this case, as the ratio is closer to 1 (or, as the difference is closer to 0), the load resistance value is closer to optimal efficiency.

In addition, a range in which a ratio (or difference) of the “V₁” and “V₂” can be obtained is divided into a plurality of ranges, and a label that indicates the goodness of efficiency is given to the divided ranges. A range to which the ratio (or difference) of the “V₁” and “V₂” calculated by the estimator 12 belongs is identified, and a label that is given to the identified range may be regarded as the efficiency.

Similarly, a range in which a ratio (or difference) of the above-described voltage ratio and the “√/(R₂/R₁)” can be obtained is divided into a plurality of ranges, a label that indicates the goodness of efficiency is given to the divided ranges. A range to which the ratio (or difference) of the voltage ratio and the “√(R₂/R₁)” calculated by the estimator 12 belongs is identified, and a label that is given to the identified range may be regarded as the efficiency.

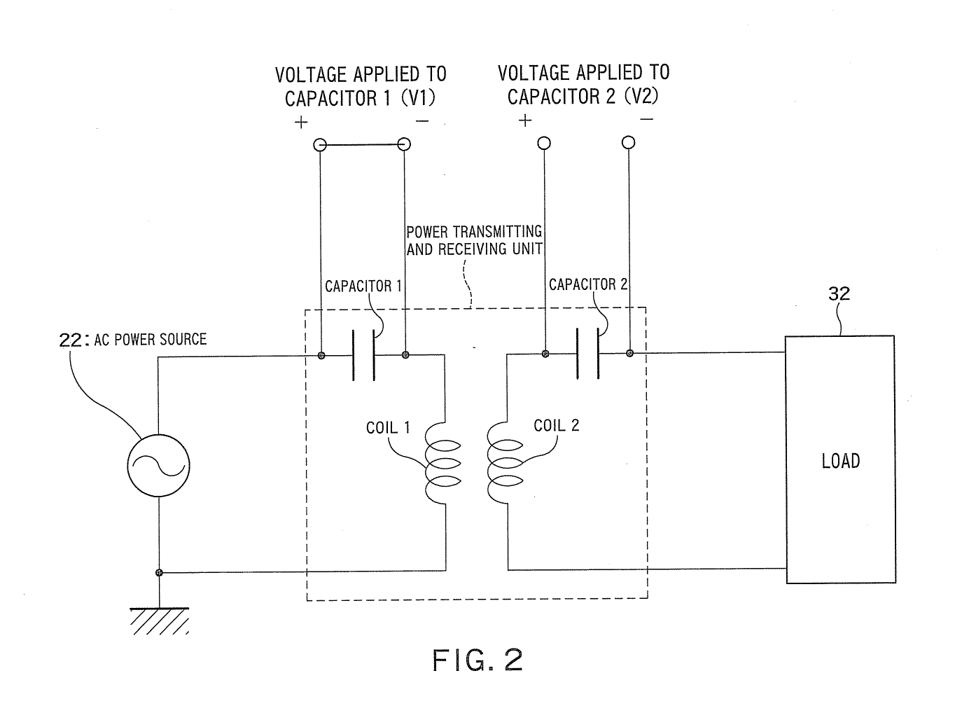

In an example of FIG. 1, the transmission efficiency has been estimated using the voltage of the terminal 1 and the voltage of the terminal 2; however, as illustrated in FIG. 2, the transmission efficiency may be estimated using the voltage across the capacitor 1 and the voltage across the capacitor 2. In this case, the detector 1 and the detector 2 in the control device 11 detect the voltage across the capacitor 1 and the voltage across the capacitor 2, respectively. The estimator 12 estimates the transmission efficiency using the voltage across the capacitor 1 and the voltage across the capacitor 2. It is noted that the illustration of the control device is omitted in FIG. 2.

In this example, the transmission efficiency can be represented by the following equation.

$${V}_{2} = {V}_{1} \frac{jk \sqrt{{L}_{1} {L}_{2}} {Q}_{2}}{{L}_{1} \sqrt{{k}^{2} {Q}_{1} {Q}_{2} + 1} + {L}_{1}} \qquad ( 6 )$$

The “V₁” and “V₂” are the voltage across the capacitor 1 and the voltage across the capacitor 2, respectively. When absolute values are obtained and the approximation is performed, the following equations are obtained.

$$\begin{matrix}\vert {V}_{2} \vert \approx \vert {V}_{1} \vert \frac{{L}_{1}}{{L}_{2}} \sqrt{\frac{{L}_{1} {Q}_{2}}{{L}_{2} {Q}_{1}}} \\ \approx \vert {V}_{1} \vert \frac{{L}_{1}}{{L}_{2}} \sqrt{\frac{{R}_{1}}{{R}_{2}}} ( 8 )\end{matrix} \qquad ( 7 )$$

The ratio of the “V₁” and “V₂” becomes a value that is determined depending on an inductance ratio and a parasitic resistance ratio. That is, the closeness between the resistance of the load 32 currently connected and the load resistance value having optimal efficiency can be determined by comparing the voltage ratio of the capacitors 1 and 2 with a predetermined value (threshold value) that is determined depending on the inductance ratio and the parasitic resistance ratio. The specific estimation method may be performed similarly to the above-described case of using the voltage of the terminal 1 and voltage of the terminal 2.

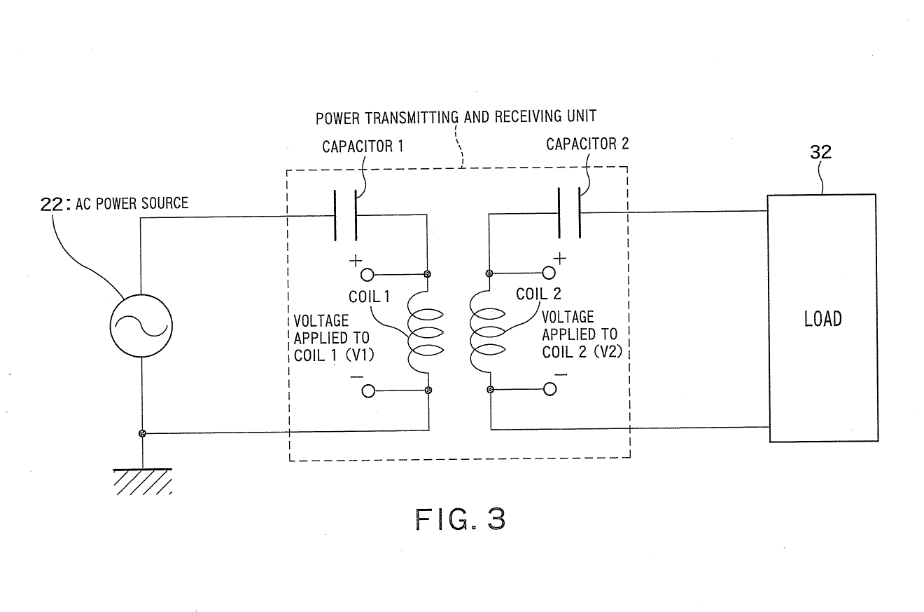

In an example of FIG. 2, the transmission efficiency has been estimated by using the voltage across the capacitor 1 and the voltage across the capacitor 2; however, as illustrated in FIG. 3, the transmission efficiency may be estimated by using the voltage across the coil 1 and the voltage across the coil 2. In this case, the detector 1 and the detector 2 in the control device 11 detect the voltage across the coil 1 and the voltage across the coil 2, respectively. It is noted that illustration of the control device is omitted in FIG. 3. The estimator 12 estimates the transmission efficiency by using the voltage across the coil 1 and the voltage across the coil 2.

In this example, the transmission efficiency can be represented as the following equation.

$${V}_{2} = {V}_{1} \frac{jk {L}_{1} \sqrt{{L}_{1} {L}_{2}} {Q}_{2}}{{L}_{2}^{2} \sqrt{{k}^{2} {Q}_{1} {Q}_{2} + 1} + {L}_{2}^{2}} \qquad ( 9 )$$

The “V₁” and “V₂” are the voltage across the coil 1 and the voltage across the coil 2, respectively. When absolute values are obtained and the approximation is performed, the following equations are obtained.

$$\begin{matrix}\vert {V}_{2} \vert \approx \vert {V}_{1} \vert \sqrt{\frac{{L}_{2} {Q}_{2}}{{L}_{1} {Q}_{1}}} \\ \approx \vert {V}_{1} \vert \frac{{L}_{2}}{{L}_{1}} \sqrt{\frac{{R}_{1}}{{R}_{2}}} ( 11 )\end{matrix} \qquad ( 10 )$$

That is, in this case, the ratio of the “V₁” and “V₂” becomes a value that is determined depending on the inductance ratio and the parasitic resistance ratio. That is, the closeness between the resistance of the load 32 currently connected and the load resistance having optimal efficiency can be determined by comparing the voltage ratio of the coils 1 and 2 with the predetermined value (threshold value) that is determined depending on the inductance ratio and the parasitic resistance ratio. The specific estimation method may be performed similarly to the above-described case of using the above-described voltage of the terminals 1 and voltage of the terminal 2.

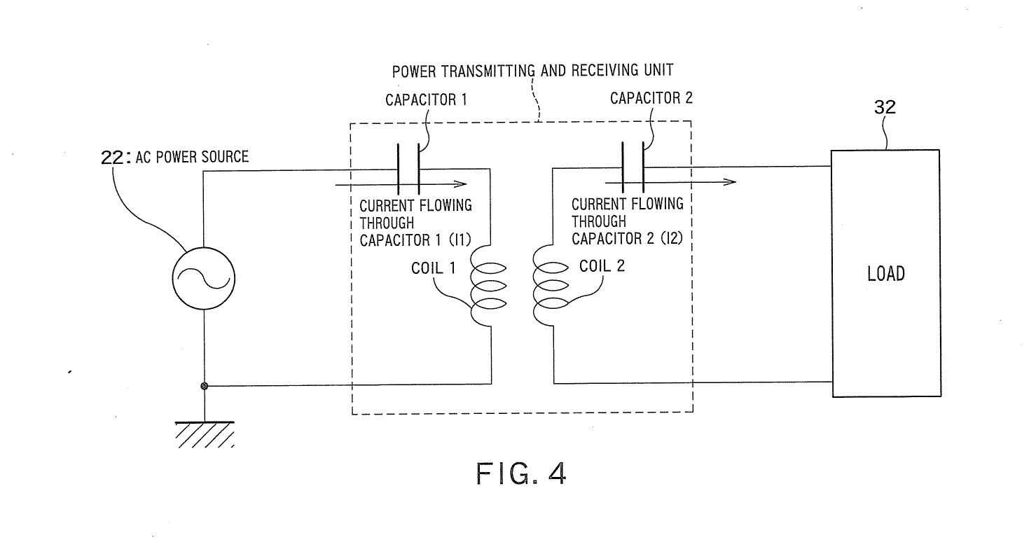

In the examples illustrated in FIGS. 1 to 3, transmission efficiency is estimated using voltage of the terminal 1 and voltage of the terminal 2, and alternately, as illustrated in FIG. 4, transmission efficiency may be estimated using current that flows through the capacitors 1 and 2. In this case, in the control device 11, the detector 1 detects current that flows through the capacitor 1, and the detector 2 detects current that flows through the capacitor 2. The estimator 12 estimates transmission efficiency using current that flows through the capacitor 1 and current that flows through the capacitor 2. It is noted that illustration of the control device is omitted in FIG. 4.

In this example, transmission efficiency can be represented as the following equation.

$${I}_{2} = {I}_{1} \frac{jk \sqrt{{L}_{1} {L}_{2}} {Q}_{2}}{{L}_{2} \sqrt{{k}^{2} {Q}_{1} {Q}_{2} + 1} + {L}_{2}} \qquad ( 12 )$$

The “I₁.” and “I₂” are current that flows through the capacitor 1 and current that flows through the capacitor 2. When the approximation is performed, the following equation is obtained.

$$\begin{matrix}\vert {I}_{2} \vert \approx \vert {I}_{1} \vert \sqrt{\frac{{L}_{1}}{{L}_{2}}} \sqrt{\frac{{Q}_{2}}{{Q}_{1}}} \\ \approx \vert {I}_{1} \vert \sqrt{\frac{{R}_{1}}{{R}_{2}}} ( 14 )\end{matrix} \qquad ( 13 )$$

The current ratio becomes a value that is determined depending on a ratio of the “R₁.” and “R₂”, that is, the closeness between the resistance of the currently connected load 32 currently connected and the load resistance having optimal efficiency can be determined by comparing a ratio of the current that flows through the capacitor 1 and the current that flows through the capacitor 2 with the predetermined value (threshold value) that is determined depending on the ratio of the “R₁” and “R₂”. The specific estimation method may be performed similarly to the above-described case of using the voltage of the terminal 1 and the voltage of the terminal 2.

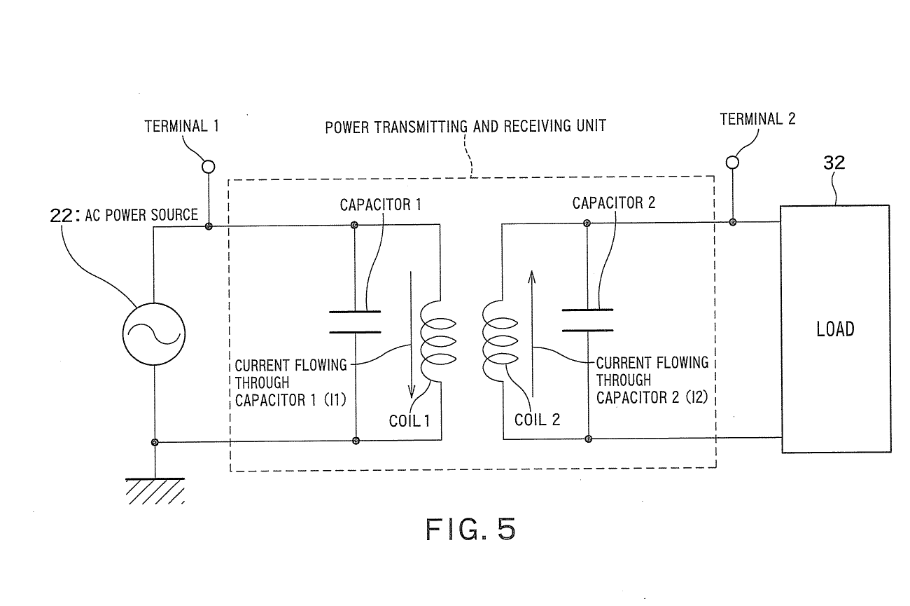

In the examples illustrated in FIGS. 1 to 4, the case has been described above in which the capacitor 1 and the capacitor 2 are connected to the coil 1 and the coil 2 in series, respectively; however, as illustrated in FIG. 5, the capacitor 1 and the capacitor 2 may be connected to the coil 1 and the coil 2 in parallel, respectively. It is noted that illustration of the control device is omitted in FIG. 5.

At this time, when a resonant frequency of the LC resonant circuit including the capacitor 2 and the coil 2 is well close to a frequency of electric power that is output from the AC power source 22, a relationship of the voltage of the terminal 1 and the voltage of the terminal 2 when the load resistance 32 of a resistance value having optimal efficiency is connected is obtained as the following equation (15).

It is noted that, in the configuration of FIG. 5, a value of the capacitor 2 having optimal efficiency substantially coincides with a value of the capacitor 2 when the LC resonant circuit including the capacitor 2 and the coil 2 resonates with a frequency of electric power that is output from the AC power source 22 in a case of satisfying “k²<<1”. Therefore, a mere equation in the case where the LC resonant circuit including the capacitor 2 and the coil 2 resonates with a frequency of electric power that is output from the AC power source 22 will be described below.

$${V}_{2} = {V}_{1} \frac{{k}_{1} \sqrt{{L}_{1} {L}_{2}} {Q}_{1} {Q}_{2} \sqrt{\frac{{Q}_{2}^{2} + {k}^{2} {Q}_{1} {Q}_{2} + 1}{{k}^{2} {Q}_{1} {Q}_{2} + 1}}}{\begin{matrix}( {k}^{2} {L}_{1} {Q}_{1} {Q}_{2} + j {L}_{1} {Q}_{1} + {L}_{1} ) \sqrt{\frac{{Q}_{2}^{2} + {k}^{2} {Q}_{1} {Q}_{2} + 1}{{k}^{2} {Q}_{1} {Q}_{2} + 1}} + \\ ( ( j - {jk}^{2} ) {L}_{1} {Q}_{1} + {L}_{1} ) {Q}_{2} + {L}_{1} {Q}_{1} - j {L}_{1}\end{matrix}} \qquad ( 15 )$$

Here, the “V₁” and “V₂” are the voltage of the terminal 1 and the voltage of the terminal 2, respectively. In a case in which “k²<<1” is satisfied for the coupling coefficient “k” and the “Q₁” and “Q₂” have substantially the same size, when absolute values on both the sides are obtained, the approximation can be performed as the following equation.

$$\begin{matrix}\vert {V}_{2} \vert \approx \vert {V}_{1} \vert \frac{\sqrt{{L}_{2}} \sqrt{{Q}_{2}}}{( \sqrt{{L}_{1}} \sqrt{{Q}_{1}} )} \\ \approx \vert {V}_{1} \vert \frac{{L}_{2}}{{L}_{1}} \sqrt{\frac{{R}_{1}}{{R}_{2}}} ( 17 )\end{matrix} \qquad ( 16 )$$

That is, the relationship of the “V₁” and “V₂” can be approximated using the inductance ratio and the parasitic resistance ratio. That is, the closeness between the resistance of the load 32 currently connected and the load resistance having optimal efficiency can be determined by comparing the voltage ratio of the terminal 1 and the terminal 2 with the predetermined value (threshold value) that is determined depending on the inductance ratio and the parasitic resistance ratio. The specific estimation method may be performed similarly to the above-described case of using the voltage of the terminal 1 and the voltage of the terminal 2.

In addition, in the configuration of FIG. 5, the transmission efficiency can be estimated by using the current that flows through the coil 1 and the current that flows through the coil 2.

At this time, the current that flows through the coil 1 and the current that flows through the coil 2 when a load resistance value has maximum efficiency are obtained as represented in the following equation.

$${I}_{2} = {I}_{1} \frac{k \sqrt{{L}_{1}} {Q}_{2} ( j \sqrt{{k}^{2} {Q}_{1} {Q}_{2} + 1} \sqrt{{Q}_{2}^{2} + {k}^{2} {Q}_{1} {Q}_{2} + 1} + {k}^{2} {Q}_{1} {Q}_{2} + 1 )}{\sqrt{{L}_{2}} ( - \sqrt{{k}^{2} {Q}_{1} {Q}_{2} + 1} \sqrt{{Q}_{2}^{2} + {k}^{2} {Q}_{1} {Q}_{2} + 1} - {k}^{2} {Q}_{1} {Q}_{2}^{2} + j ( {k}^{2} {Q}_{1} {Q}_{2} + 1 ) - {Q}_{2} )} \qquad ( 18 )$$

The “I₁” and “I₂” are the current that flows through the coil 1 and the current that flows through the coil 2, respectively. In the same way as described above, when the approximation is performed, the following equation is obtained.

$$\vert {I}_{2} \vert \approx \vert {I}_{1} \vert \sqrt{\frac{{R}_{1}}{{R}_{2}}} \qquad ( 19 )$$

The current ratio can be also approximated by a relational equation based on a ratio of the parasitic resistances “R₁” and “R₂.” That is, the closeness between the resistance of the load 32 currently connected and the load resistance having optimal efficiency can be determined by comparing the current that flows through the coil 1 and the current that flows through the coil 2 with the predetermined value (threshold value) that is determined depending on the ratio of the parasitic resistances “R₁” and “R₂.” The specific estimation method may be performed similarly to the above-described method.

Similarly, the relationship of the current that flows through the capacitor 1 and the current that flows through the capacitor 2 in FIG. 5 can be approximated by the relational equation based on the ratio of the “R₁” and “R₂.” The detail description of the approximation is omitted because it is apparent from the above description.

As a configuration different from the configurations of FIGS. 1 and 5, a capacitor may be arranged in series in one of the coil 1 and the coil 2, and a capacitor may be arranged in parallel in the other of the coil 1 and the coil 2. In either case, a relationship between the voltage or current of the power transmission side and the voltage or current of the power reception side when a load of the resistance value having maximum efficiency is connected can be approximated by a relational equation using a ratio of an inductance value and a parasitic resistance value, in the same way.

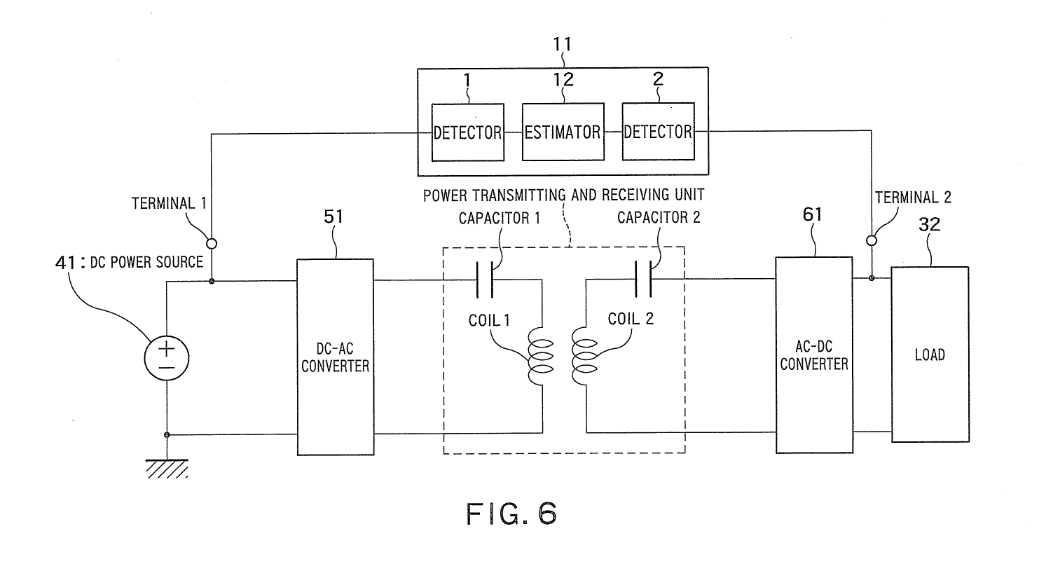

FIG. 6 illustrates a configuration example in which a DC power source and a DC-AC converter are arranged on the power transmission side and an AC-DC converter is arranged on the power reception side. The AC power source on the power transmission side in FIG. 1 is replaced with a DC power source 41, and a DC-AC converter 51 is added. An AC-DC converter 61 is added on the power reception side. The same reference numerals are given to elements that have the same name as the elements in FIG. 1, the redundant description is omitted.

In the configuration of FIG. 6, input voltage or current in the DC-AC converter 51 and output voltage or current in the AC-DC converter 61 can be used as voltage or current used for the efficiency estimation. In this case, the threshold value is the value which is converted from the threshold value used in the configurations indicated in FIGS. 1 to 5 according to the conversion ratio of the DC-AC converter and the AC-DC converter.

The detector 1 detects the input voltage or current in the DC-AC converter 51, and the detector 2 detects the output voltage or current in the AC-DC converter 61. The estimator 12 estimates the transmission efficiency using the voltage or current detected by the detector 1 and the voltage or current detected by the detector 2 as described above with reference to FIGS. 1 and 5. It is noted that the DC-AC converter 51 may be constituted of, for example, an inverter, and the AC-DC converter 61 may be constituted of, for example, a rectifier.

In the configuration of FIG. 6, an embodiment can be more simply performed by detecting DC voltage or DC current.

As described above, according to the present embodiment, the power transmission efficiency can be estimated with a simple configuration.

### Second Embodiment

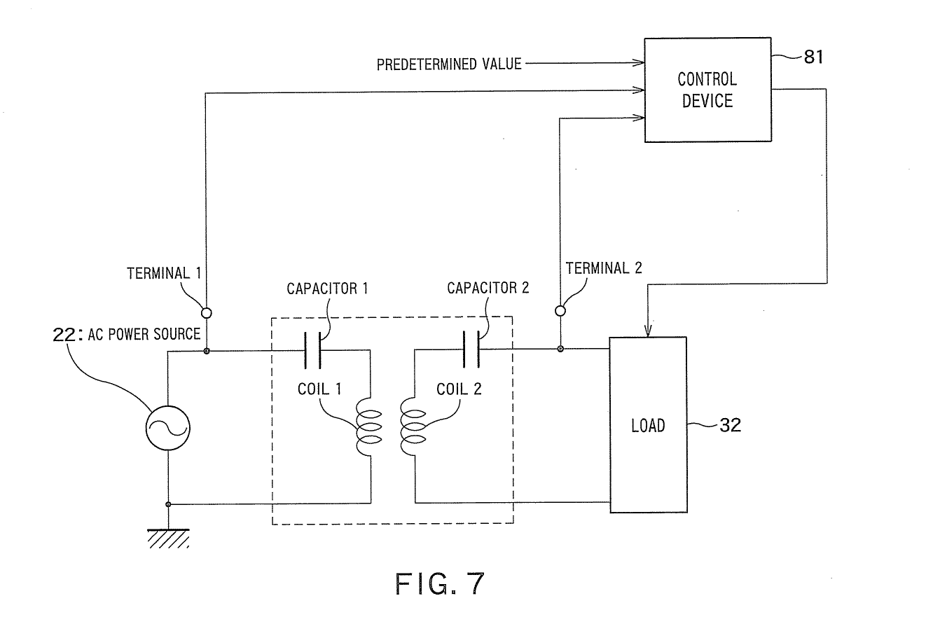

FIG. 7 illustrates a wireless power transmitting apparatus according to a second embodiment, which includes a control device. A control device 81 is obtained by extending the functions of the control device in FIG. 1, and the control device 81 includes a function to automatically adjust load resistance of the load 32 in accordance with the estimated efficiency.

The control device 81 adjusts the load resistance value of the load 32 to become closer to the optimal transmission efficiency using the voltage detected in the terminal 1, the voltage detected in the terminal 2, and a predetermined value.

An operation according to the second embodiment will be described below in detail.

The control device 81 controls load resistance so that a voltage ratio of the terminals 1 and 2 is closer to or coincides with the predetermined value (threshold value). For example, when the predetermined value (threshold value) is 1, the control device 81 controls the load resistance so that the voltage ratio coincides with 1. Alternatively, when the predetermined value (threshold value) is 1, the control device 81 may control a voltage difference to coincide with 0, instead of controlling the voltage ratio to coincide with 1. A direction to be controlled is determined based on whether the voltage ratio is greater or smaller than the predetermined value (threshold value). For example, it is sufficient that the control device 81 increase the load resistance value when the voltage ratio “V₁/V₂” is greater than the predetermined value (threshold value), and decrease the load resistance value when the voltage ratio “V₁/V₂” is smaller than the predetermined value (threshold value). As an example of control of the load resistance, when the load 32 is a load unit that includes a DC-DC converter, a change of a voltage conversion ratio of the DC-DC converter is included. This is just an example, and the present embodiment is not limited to this.

The operation of the control device in the configuration of FIG. 1 has been described above, and similarly in the case of the configuration illustrated in FIGS. 2 to 5, the load resistance control may be performed using the predetermined value (threshold value), based on the detected voltage or the detected current.

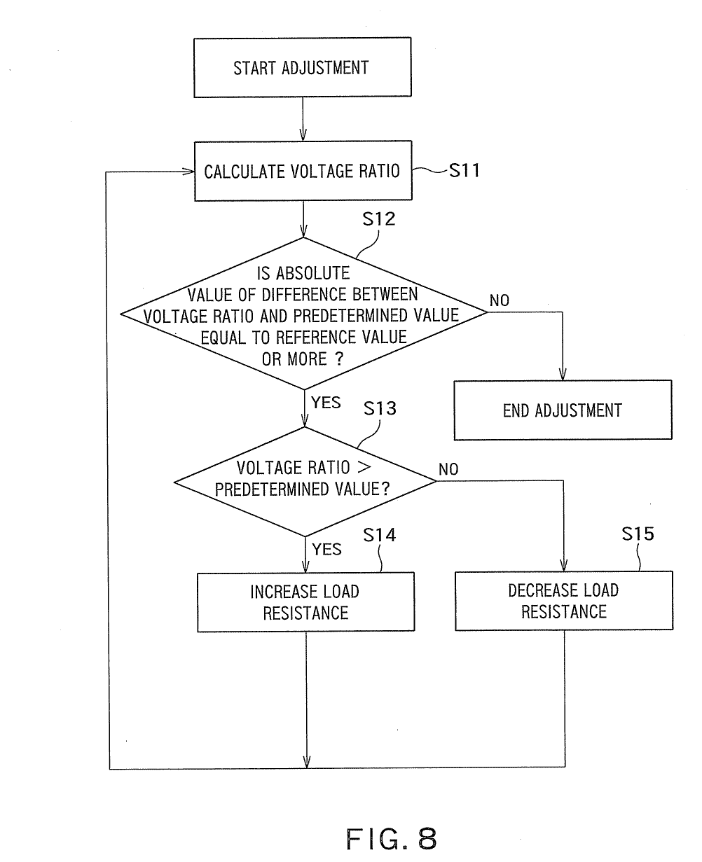

FIG. 8 illustrates an example of an operation flow of the load resistance adjustment by the control device 81 illustrated in FIG. 7.

The control device 81 calculates the ratio of the voltage in the terminal 1 and the voltage in the terminal 2 (step S11), and checks whether or not an absolute value of a difference between the voltage ratio and the predetermined value (threshold value) is equal to the threshold value (reference value) or more (step S12). When the difference is less than the reference value, the control device 81 determines that proper transmission efficiency is obtained, and terminates the process. On the other hand, when the difference is equal to the reference value or more, the control device 81 compares a magnitude relation between the voltage ratio and the predetermined value (threshold value) (step S13); the control device 81 controls the load resistance to be increased when the voltage ratio is greater (step S14), and controls the load resistance to be decreased when the predetermined value is greater (step S15).

It is noted that the order of increasing the load resistance in step S14 and decreasing the load resistance value in step S15 of FIG. 8 may be reversed depending on a configuration.

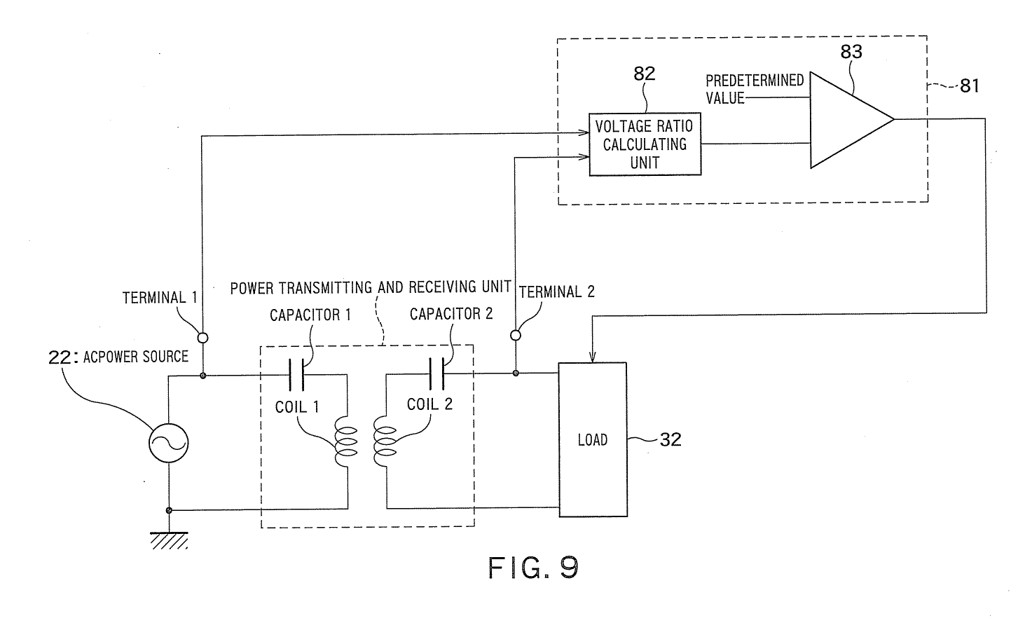

As a specific configuration example of the control device 81, a feedback configuration as illustrated in FIG. 9 may be used. A voltage ratio calculating unit (estimator, detector 1, detector 2) 82 calculates the ratio of the voltage in the terminal 1 and the voltage in the terminal 2, an amplifier (controller) 83 amplifies a difference between the voltage ratio and the predetermined value (threshold value), and imparts the amplified difference to the load 32. The load resistance of the load 32 is controlled in accordance with amplification signals.

In the present embodiment, the example in which the voltage ratio is controlled to be closer to or coincide with the predetermined value by adjusting the load resistance value of the load 32 has been illustrated; alternatively, another method in which the voltage ratio is controlled to be closer to or coincide with the predetermined value can be performed by adjusting the inductance or the coupling coefficient.

For example, as a change of the inductance, a change of the arrangement of a magnetic material in a coil or around a coil (including addition and deletion of the magnetic material) can be performed. A coil that is included in one of or both of the power transmitting unit and the power receiving unit is targeted.

In addition, as a change of the coupling coefficient, a change of a relative position between coils in the power transmitting unit and the power receiving unit can be performed. Alternatively, similarly to the change of the inductance, the change of the arrangement of the magnetic material in a coil or around a coil (including addition and deletion of the magnetic material) can be performed.

As described above, in the second embodiment, the load (impedance) can be adjusted to a value closer to the load resistance value having optimal efficiency. In addition, the inductance or the coupling coefficient can be adjusted to a value closer to the load resistance value having optimal efficiency.

### Third Embodiment

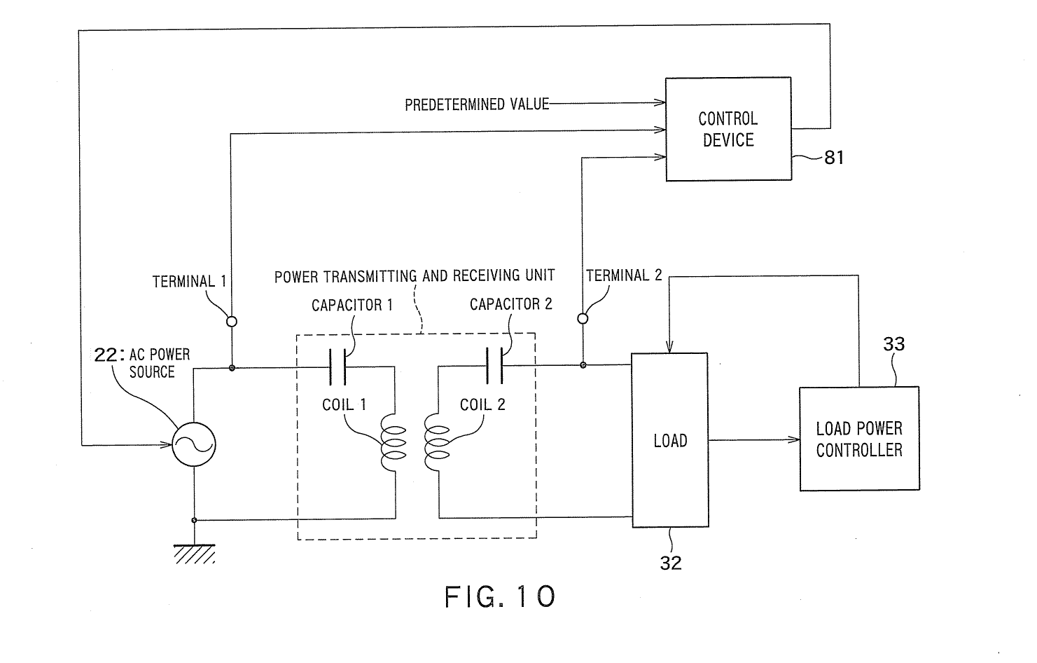

FIG. 10 illustrates a wireless power transmitting apparatus according to a third embodiment. A load power controller 33 is added on the power reception side, and the functions of the control device 81 are extended. The same reference numerals are given to elements that have the same name as the elements in FIG. 9.

The load power controller 33 includes a function to adjust electric power supplied to the load 32 to be a constant value. The load 32 is realized, for example, by a DC-DC converter and a device which consumes or stores electric power, etc., and the load power controller 33 controls the load resistance (impedance) of the load 32 so as to be constant voltage, constant current, constant electric power, etc. at the power consume or store device.

The control device 81 adjusts the AC power source 22 on the power transmission side so that the voltage ratio of the terminal 1 and the terminal 2 becomes the predetermined value (threshold value) (that is, optimal transmission efficiency is obtained). The adjustment of the AC power source can be achieved by changing an AC waveform. As a change of a waveform, for example, changes of voltage amplitude, a duty ratio, a phase (phase relationship between phases in a multi-phase inverter), etc. are included.

In the third embodiment, the power transmission having high transmission efficiency can be realized while electric power of the load 32 is kept at a constant value.

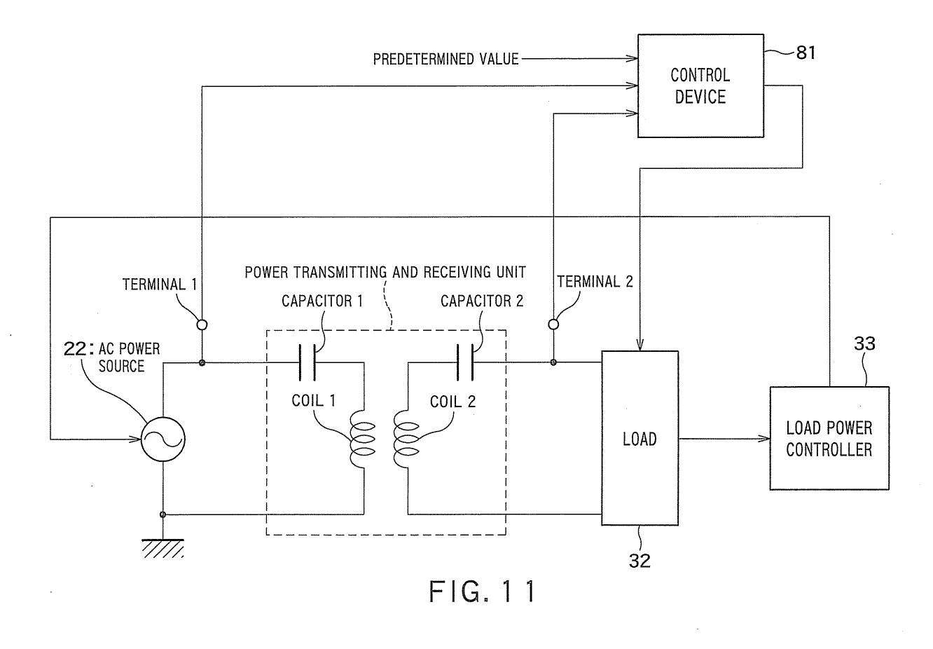

FIG. 11 illustrates another configuration example of the wireless power transmitting apparatus according to the third embodiment. In FIG. 11, the functions of the control device and the load power controller are partially changed from the functions in FIG. 10. The same reference numerals are given to elements that have the same name as the elements in FIG. 10.

In the configuration of FIG. 11, the load power controller 33 adjusts the AC power source 22 so that electric power of the load 32 is kept at a constant value. The control device 81 adjusts the load resistance of the load 32 so that the voltage ratio of the terminal 1 and the terminal 2 becomes the predetermined value (threshold value). This also allows the power transmission having high transmission efficiency to be realized while causing electric power of the load 32 to be a constant value.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A control device that estimates power transmission efficiency between a power transmitting unit and a power receiving unit, the power transmitting unit including a first coil and a first capacitor connected to the first coil in parallel or in series, and the power receiving unit including a second coil and a second capacitor connected to the second coil in parallel or in series and receiving electric power from the power transmitting unit through a coupling between the first coil and the second coil, the control device comprising:
an estimator configured to compare a detected value of a first voltage or a first current at a first location in the power transmitting unit with a detected value of second voltage or second current at a second location in the power receiving unit and estimate the power transmission efficiency from the power transmitting unit to the power receiving unit based on comparative result.

2. The control device according to claim 1, wherein
the estimator calculates a voltage ratio of the first voltage and the second voltage or a current ratio of the first current and the second current, and estimates the power transmission efficiency based on the voltage ratio or the current ratio.

3. The control device according to claim 2, wherein
the estimator estimates the power transmission efficiency by comparing the voltage ratio or the current ratio with a threshold value.

4. The control device according to claim 3, wherein
the threshold value is:
a value depending on a ratio of parasitic resistance of the first coil and parasitic resistance of the second coil;
a value depending on a ratio of inductance of the first coil and inductance of the second coil; or
a value depending on both the ratio of the parasitic resistance of the first coil and the parasitic resistance of the second coil and the ratio of the inductance of the first coil and the inductance of the second coil.

5. The control device according to claim 1, wherein
the first voltage is voltage of a terminal, among terminals of the first capacitor, different from that connected to the first coil; voltage of a terminal, among terminals of the first coil, different from that connected to the first capacitor; voltage of the first capacitor; or voltage of the first coil,
the first current is current that flows through the first capacitor or current that flows through the first coil,
the second voltage is voltage of a terminal, among terminals of the second capacitor, different from that connected to the second coil; voltage of a terminal, among terminals of the second coil, different from that connected to the second capacitor; voltage of the second capacitor; or voltage of the second coil, and
the second current is current that flows through the second capacitor or current that flows through the second coil.

6. The control device according to claim 1, wherein
the power transmitting unit comprises a DC power supply that generates a DC power signal, and a DC-AC converter that performs DC-AC conversion on the DC power signal and supplies converted power signal to the first capacitor and the first coil,
the power receiving unit comprises an AC-DC converter that performs AC-DC conversion on a power signal that is received from the power transmitting unit,
the first voltage or the first current is input voltage or input current of the DC-AC converter, respectively, and
the second voltage or the second current is output voltage or output current of the AC-DC converter, respectively.

7. The control device according to claim 3, wherein
impedance of a load in the power receiving unit is adjusted so that the voltage ratio or the current ratio is closer to the threshold value.

8. The control device according to claim 3, wherein
inductance of at least one of the first coil and the second coil is adjusted so that the voltage ratio or the current ratio is closer to the threshold value.

9. The control device according to claim 3, wherein
a coupling coefficient between the first coil and the second coil is adjusted so that the voltage ratio or the current ratio is closer to the threshold value.

10. A wireless power transmitting apparatus comprising:
a power receiving unit including a coil and a capacitor connected to the coil in parallel or in series, which receives electric power from a power transmitting unit through the coil, and
a control device including an estimator that compares a detected value of first voltage or first current at a first location in the power transmitting unit with a detected value of second voltage or second current at a second location in the power receiving unit and estimates power transmission efficiency from the power transmitting unit to the power receiving unit based on comparative result.

11. The wireless power transmitting apparatus according to claim 10, wherein
the power receiving unit includes a load that uses electric power received from the power transmitting unit,
the estimator calculates a voltage ratio of the first voltage and the second voltage or a current ratio of the first current and the second current,
the control device changes a waveform of a power signal generated by an AC power source in the power transmitting unit so that the voltage ratio or the current ratio is closer to a threshold value, and
the power receiving unit includes a load power controller that controls impedance of the load so that electric power of the load is kept constant.

12. The wireless power transmitting apparatus according to claim 10, wherein
the power receiving unit includes a load that uses electric power received from the power transmitting unit,
the estimator calculates a voltage ratio of the first voltage and the second voltage or a current ratio of the first current and the second current,
the control device controls impedance of the load so that the voltage ratio or the current ratio is closer to a threshold value, and
the power receiving unit includes a load power controller that changes a waveform of a power signal generated by the AC power source so that electric power of the load is kept constant.

13. A power transmission efficiency estimation method comprising:
detecting first voltage or first current at a first location in a power transmitting unit that includes a first coil and a first capacitor that is connected to the first coil in parallel or in series;
detecting second voltage or second current at a second location in a power receiving unit that includes a second coil and a second capacitor that is connected to the second coil in parallel or in series, and receives electric power from the power transmitting unit through a coupling between the first coil and the second coil; and
comparing the first voltage with the second voltage or comparing the first current with the second current and estimating power transmission efficiency from the power transmitting unit to the power receiving unit based on comparative result.
